(19) United States
(12) Patent Application Publication
(10) Pub. No.: US 2026/0034497 A1
(43) Pub. Date: Feb. 5, 2026

(54) AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/184,036

(22) Filed: Apr. 21, 2025

(30) Foreign Application Priority Data
Aug. 2, 2024 (JP) 2024-128144

(51) Int. Cl. B01D 53/04; B01D 53/62; B01D 53/96; B60H 1/22; F24F 8/108

(52) U.S. Cl. CPC B01D 53/0438; B01D 53/62; B01D 53/96; B60H 1/2225; F24F 8/108; B01D 2253/3425; B01D 2257/504; B01D 2257/708; B01D 2257/80; B01D 2259/40088; B01D 2259/4566

(57) ABSTRACT

A vehicle air conditioning system includes: an air conditioning duct through which air can flow; at least one air conditioning device provided in the air conditioning duct, the at least one air conditioning device including an adsorption portion having an adsorbent configured to adsorb and separate an adsorption target substance, and a heating means configured to heat the adsorption portion; and a control unit configured to control a flow velocity of air flowing through the air conditioning duct and heating of the adsorption portion. The control unit repeatedly executes an adsorption mode in which the heating means of the air conditioning device is not activated, and a regeneration mode in which the heating means of the air conditioning device is activated, and executes the regeneration mode at start-up.

### CROSS REFERENCE TO RELATED APPLICATIONS

This application claims the benefit of priority to Japanese Patent Application No 2024-128144 filed on Aug. 2, 2024 with the Japanese Patent Office, the entire contents of which are incorporated herein by reference in its entirety.

### FIELD OF THE INVENTION

The disclosure may relate relates to an air conditioning system.

### BACKGROUND OF THE INVENTION

In various buildings such as offices, schools, and houses, and various types of vehicles such as automobiles, there are increasing requirements for improvement of vehicle interior environment. Specific requirements illustrate reduction of an amount of CO₂ in a room interior to suppress drowsiness, control of humidity in the room interior, and removal of harmful volatile components such as odor components and allergy-causing components in the room interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, Patent Literature 1 proposes an air conditioning system (vehicle interior purifying system) comprising a heater element including: a honeycomb structure having an outer peripheral wall and partition walls disposed on an inner side of the outer peripheral wall, the partition walls defining a plurality of cells each extending from one end face to other end face of the honeycomb structure to form a flow path, at least the partition walls having a material having a PTC (Positive Temperature Coefficient) property; and a pair of electrodes provided on certain positions of the honeycomb structure, wherein the heater element has an adsorption portion (a functional material-containing layer) for adsorbing an adsorption target substance (water vapor, CO₂ and the like) on surfaces of the partition walls.

However, the air conditioning system of Patent Literature 1 has a problem of low adsorption performance of the adsorption target substance in the initial stage (especially at start-up). This is because when the air conditioning system is stopped, the adsorption target substance is adsorbed by the adsorption portion, so that an amount of the adsorption target substance that can be adsorbed in the initial stage will decrease. Although the adsorption performance of the adsorption portion is gradually restored by repeating the adsorption mode and the regeneration mode of the adsorption portion, in the initial stage the adsorption mode is performed under conditions where the adsorption efficiency of the adsorption target substance is lower, which can result in energy loss and fogging of windows.

This disclosure has been made to solve the above problems, and an object of this disclosure is to provide an air conditioning system that can efficiently adsorb the adsorption target substance even in the initial stage.

### PRIOR ART

### Patent Literature

[Patent Literature 1] WO 2023/074202 A1

### SUMMARY OF THE INVENTION

As a result of extensive studies for air conditioning systems including air conditioning devices, the inventor has found that that by performing the regeneration mode at startup, the adsorption performance of the adsorption portion for the adsorption target substance can be rapidly and efficiently restored, and the adsorption performance of the adsorption target substance in the initial stage can be improved, and has completed one or more embodiments of the disclosure. In other words, the embodiments are exemplified as follows:
<1> An air conditioning system, comprising:
   an air conditioning duct through which air can flow;
   at least one air conditioning device provided in the air conditioning duct, the at least one air conditioning device comprising an adsorption portion having at least one adsorbent configured to adsorb and separate an adsorption target substance, and a heating means configured to heat the adsorption portion; and
   a control unit configured to control a flow velocity of air flowing through the air conditioning duct and heating of the adsorption portion,
   wherein the control unit repeatedly executes an adsorption mode in which the heating means of the air conditioning device is not activated, and a regeneration mode in which the heating means of the air conditioning device is activated, and executes the regeneration mode at start-up.
<2> The air conditioning system according to <1>, wherein a time during the regeneration mode at the start-up may be longer than a time during the regeneration mode other than the start-up.
<3> The air conditioning system according to <1> or <2>, wherein the control unit may execute the regeneration mode at the start-up until an adsorbed amount of the adsorption portion is 20% or less of the maximum adsorbed amount.
<4> The air conditioning system according to <3>, wherein the control unit may previously determine a relationship between a time during the regeneration mode and an adsorbed amount of the adsorption portion, measure the adsorbed amount of the adsorption portion at the start-up, and calculate a time during the regeneration mode at the start-up based on the relationship and calculate the regeneration mode.
<5> The air conditioning system as according to <1> or <2>, wherein the control unit may measure amounts of components contained in the air that passed through the air conditioning device during the regeneration mode at the start-up, and determines the end of the regeneration mode at the start-up based on results of the measurement.
<6> The air conditioning system according to any one of <1> to <6>, wherein the air conditioning device may include:
   a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
   an adsorbing layer comprising the adsorbent, the adsorbing layer being provided on a surface of each of the partition walls; and
   a pair of electrodes provided on the first end face and the second end face of the honeycomb structure, or on the outer peripheral wall parallel to the extending direction of the cells of the honeycomb structure.
<7> The air conditioning system according to <6>, wherein at least the partition walls of the honeycomb structure may be made of a material having a PTC property.
<8> The air conditioning system according to any one of <1> to <7>, wherein the adsorbent may be configured to adsorb and release at least one selected from moisture, carbon dioxide and volatile components.
<9> The air conditioning system according to any one of <1> to <8>, wherein the air conditioning system may be for vehicles.
<10> The air conditioning system according to <9>, wherein the air conditioning duct may branch into a first flow path for allowing the air to flow into the vehicle interior and a second flow path for discharging the air to a vehicle exterior on a downstream side, and wherein the air conditioning duct may further include a valve configured to switch the flow of the air between the first flow path and the second flow path.
<11> The air conditioning system according to <10>,
   wherein the control unit may be configured to control the valve, and
   wherein the control unit may be configured to perform an adsorption mode configured to switch the valve so that the air flows into the first flow path, and a regeneration mode configured to heat the adsorption mode and switch the valve so that the air flows into the second flow path.

### BRIEF DESCRIPTION OF THE DRAWINGS

FIG. 1 is an overall schematic configuration view of an air conditioning system according to an embodiment;

FIG. 2 is a graph illustrating a relationship between an amount of an adsorption target substance adsorbed and a time when a regeneration mode is executed at start-up;

FIG. 3 is a graph illustrating a relationship between an amount of an adsorption target substance adsorbed and a time when a regeneration mode is executed at start-up;

FIG. 4A is a schematic view of a cross section of an air conditioning device used in an air conditioning system according to an embodiment, which is parallel to a flow path direction; and

FIG. 4B is a schematic cross-sectional view of the air conditioning device in FIG. 4A taken along the line a-a′.

### DETAILED DESCRIPTION OF THE INVENTION

An air conditioning system includes: an air conditioning duct through which air can flow; at least one air conditioning device provided in the air conditioning duct, the at least one air conditioning device including an adsorption portion having an adsorbent configured to adsorb and separate an adsorption target substance, and a heating means configured to heat the adsorption portion; and a control unit configured to control a flow velocity of air flowing through the air conditioning duct and heating of the adsorption portion. The control unit repeatedly executes an adsorption mode in which the heating means of the air conditioning device is not activated, and a regeneration mode in which the heating means of the air conditioning device is activated, and executes the regeneration mode at start-up. By thus configuring the air conditioning system according to the disclosure, the adsorption performance of the adsorption portion can be rapidly and efficiently restored. Therefore, even in the initial stage, the adsorption target substance can be efficiently adsorbed, so that energy loss and fogging of windows can be suppressed.

Hereinafter, embodiments of the disclosure will be specifically described with reference to the drawings. It should be understood that the disclosure is not limited to the following embodiments, and those which have appropriately added changes, improvements and the like to the following embodiments based on knowledge of a person skilled in the art without departing from the spirit of the disclosure fall within the scope of the disclosure.

The air conditioning system according to an embodiment of the disclosure can be used in various buildings such as offices, schools, and homes, and in various vehicles such as automobiles. Among these, the air conditioning system according to an embodiment can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the air conditioning system according to an embodiment can be suitably used for a vehicle that has no internal combustion engine such as electric vehicles and electric rail cars.

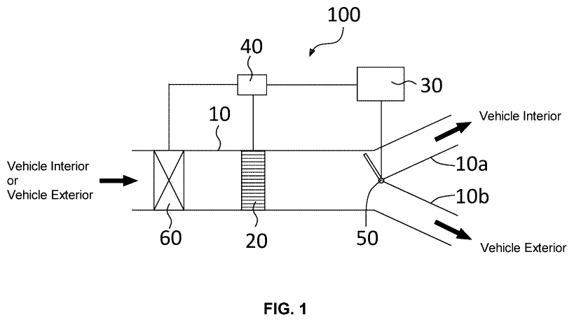

FIG. 1 is an overall schematic configuration view of an air conditioning system according to an embodiment.

As illustrated in FIG. 1, an air conditioning system 100 according to an embodiment of the disclosure includes: an air conditioning duct 10; an air conditioning device 20; and a control unit 30. Further, the air conditioning system 100 can further include: a power source 40; a valve 50; and a ventilation fan 60.

The air conditioning duct 10 can allow air from a room interior or a room exterior to flow therethrough. On a downstream side of the air conditioning device 20, the air conditioning duct 10 branches into the first flow path 10a that allows the air to flow into the room interior (vehicle interior for the vehicle), and the second flow path 10b that allows the air to be discharged to the room exterior (vehicle exterior for the vehicle). The valve 50 may be configured to switch the flow of the air between the first flow path 10a and the second flow path 10b.

The air conditioning device 20 is disposed in the air conditioning duct 10. The number of air conditioning devices 20 disposed in the air conditioning duct 10 may be one or more. When multiple air conditioning devices 20 are provided, they may be arranged in parallel or in series with respect to the flow of the air flowing through the air conditioning duct 10.

The air conditioning device 20 includes an adsorption portion having an adsorbent configured to adsorb and separate the adsorption target substance, and a heating means configured to heat the adsorption portion.

The control unit 30 can also control the flow velocity of the air flowing through the air conditioning duct 10 and the heating of the adsorption portion of the air conditioning device 20. Specifically, the control unit 30 can control the flow velocity (flow rate) of the air by adjusting the rotation speed of the ventilation fan 60 electrically connected to the control unit 30. The control unit 30 can also control whether or not the adsorption portion of the air conditioning device 20 is heated by controlling the power source 40 electrically connected to the heating means of the air conditioning device 20. The control unit 30 is also connected to the valve 50 and can control the open/close state of the valve 50.

In the air conditioning system 100 having the above structure, in both the regeneration mode in which the heating means of the air conditioning device 20 is activated (the adsorption portion is heated) and the adsorption (air conditioning) mode in which the heating means of the air conditioning device 20 is not activated (the adsorption portion is not heated), the air from room interior or room exterior flows into the air conditioning device 20 through the air conditioning duct 10. In the adsorption mode, the adsorption target substance in the air is captured (adsorbed) by the adsorption portion of the air conditioning device 20, and the air with a reduced amount of the adsorption target substance flows into the room interior through the first flow path 10a. On the other hand, in the regeneration mode, as the adsorption portion of the air conditioning device 20 is heated, the adsorption target substance captured in the adsorption portion is separated, and the air containing the adsorption target substance flows to the room exterior through the second flow path 10b.

The control unit 30 repeatedly executes the adsorption mode in which the heating means of the air conditioning device 20 is not activated, and the regeneration mode in which the heating means of the air conditioning device 20 is activated. By repeatedly executing the adsorption mode and the regeneration mode in this manner, the adsorption target substance in the air can be efficiently removed and discharged.

The control unit 30 also executes the regeneration mode at the start-up. By executing the regeneration mode at the start-up, the adsorption performance of the adsorption portion can be rapidly and efficiently recovered. Therefore, even in the initial stage, the adsorption target substance can be efficiently adsorbed, so that energy loss and fogging of windows can be suppressed.

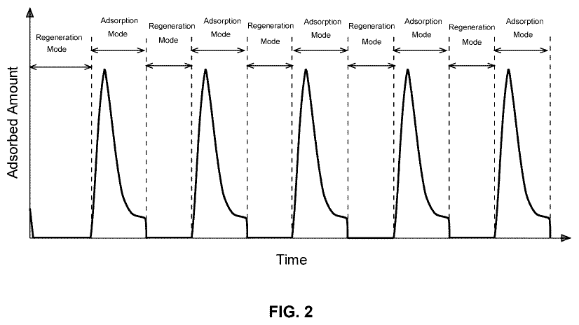

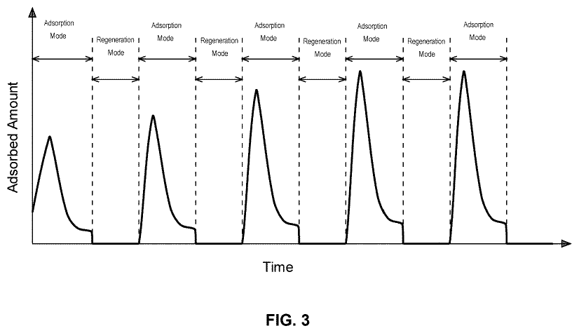

Here, FIG. 2 illustrates a graph representing a relationship between an amount of the adsorption target substance adsorbed and a time when the regeneration mode is executed at the start-up. FIG. 3 also illustrates a graph representing a relationship between an amount of the adsorption target substance adsorbed and a time when the regeneration mode is executed at the start-up.

When the regeneration mode is executed at the start-up, the amount of the adsorption target substance adsorbed can be maximized from the initial stage, as illustrated in FIG. 2. In contrast, when the adsorption mode is executed at the start-up, the amount of the adsorption target substance adsorbed in the initial stage is lower, as illustrated in FIG. 3. Although the amount of adsorption target substance adsorbed gradually increases as the adsorption mode and the regeneration mode are repeated, the adsorption performance is not sufficient in the initial stage, resulting in significant energy loss.

The time during the regeneration mode at the start-up is preferably longer than the time during the regeneration mode other than the start-up (second and subsequent regeneration modes). By controlling the time during the regeneration mode at the start-up in this manner, the adsorption performance of the adsorption portion can be stably and rapidly restored even if the adsorption target substance is adsorbed by the adsorption portion when the air conditioning system 100 is stopped.

The time during the regeneration mode at the start-up can be, for example, 1.1 to 3.0 times that during the regeneration mode other than the start-up.

The time during the regeneration mode other than the start-up may be adjusted as appropriate depending on the type of the air conditioning device 20, but it may typically be 0.33 to 10 minutes. Similarly, the time during the adsorption mode can be adjusted as appropriate depending on the type of the air conditioning device 20, but it may typically be 0.33 to 10 minutes.

The control unit 30 may execute the regeneration mode at the start-up until the absorbed amount of the adsorption portion is 20% or less of the maximum adsorbed amount, preferably 15% or less, and more preferably 10% or less. By thus controlling the regeneration mode at the start-up, the adsorption performance of the adsorption portion can be stably and rapidly restored.

As used herein, the maximum adsorbed amount of the adsorption portion means the maximum amount of the adsorption target substance adsorbed in the adsorption portion. Further, when the adsorption portion adsorbs a plurality of types of adsorption target substances, the maximum amount of the adsorption target substance that is adsorbed in the greatest amount, among the adsorption target substances to be adsorbed, is defined as the maximum adsorbed amount of the adsorption portion. For example, an adsorbent whose adsorbent substance is moisture may also adsorb a small amount of carbon dioxide, in which case the maximum amount of moisture adsorbed is defined as the maximum adsorbed amount of the adsorption portion.

The maximum adsorbed amount of the adsorption portion can be determined as follows: First, the regeneration mode is performed until the adsorption target substance is completely separated from the adsorption portion of the air conditioning device 20, and then the adsorption mode is performed until the adsorption target substance can no longer be adsorbed (until the amount of the adsorption target substance adsorbed becomes saturated). The maximum adsorbed amount of the adsorption portion can then be determined by measuring the mass of the adsorption portion before and after the adsorption mode and subtracting the mass of the adsorption portion before the adsorption mode from the mass of the adsorption portion after the adsorption mode. Alternatively, when the adsorption target substance that is the target of the maximum adsorbed amount of the adsorption portion is moisture, sensors capable of measuring the absolute humidity in the air may be provided at an inlet and outlet of the air conditioning device 20, and at the start of the adsorption mode described above, the absolute humidity (g/m³) at the inlet of the air conditioning device 20 and the absolute humidity (g/m³) at the outlet of the air conditioning device 20 may be measured to determine the absolute humidity difference (g/m³) between them, and the maximum amount (g) of moisture adsorbed by the adsorption portion may be calculated using the following equation:

maximum amount of moisture adsorbed in adsorption portion (g)=absolute humidity difference (g/m)³)×flow rate of air flowing through air conditioning device 20 (m³/sec)×time until amount of moisture adsorbed is saturated in adsorption mode (sec)

The control unit 30 may previously determine the relationship between the time during the regeneration mode and the adsorbed amount of the adsorption portion, measure the adsorbed amount of the adsorption portion at the start-up, calculate the time during the regeneration mode at the start-up based on the relationship and execute the regeneration mode. By executing the regeneration mode at the start-up in this manner, the regeneration mode at the start-up can be efficiently executed, so that waste of power consumption can be reduced.

Here, the adsorbed amount of the adsorption portion is a difference between the mass of the adsorption portion when the regeneration mode is performed until the adsorption target substance is completely separated from the adsorption portion, and the mass of the adsorption portion during the regeneration mode. Therefore, by measuring the mass of the adsorption portion at each predetermined time during the regeneration mode, it is possible to obtain in advance the relationship between the time during the regeneration mode and the adsorbed amount of the adsorption portion. Also, the adsorbed amount of the adsorption portion at the start-up can be determined by measuring the mass of the adsorption portion at the start-up and subtracting the mass of the adsorption portion when the regeneration mode is performed until the adsorption target substance is completely separated from the adsorption portion from that mass of the adsorbed amount at the start-up.

The control unit 30 may measure amounts of components contained in the air that passed through the air conditioning device during the regeneration mode at the start-up (in particular, a content of the adsorption target substance in the air), and determine the end of the regeneration mode at the start-up based on results of the measurement. Specifically, sensors capable of measuring the content of the adsorption target substance in the air may be provided at the inlet and outlet of the air conditioning device 20, and the regeneration mode at the start-up may be terminated at a stage where the content of the adsorption target substance in the air at the outlet of the air conditioning device 20 is 20% or more of the content of the adsorption target substance in the air at the inlet of the air conditioning device 20. In addition, when the adsorption target substance is moisture, the moisture content (humidity) in the room interior measured by a hygrometer installed in the room interior (vehicle interior for the vehicle) may be used in place of measuring the moisture content in the air using the sensor provided at the inlet of the air conditioning device 20, and the regeneration mode at the start-up may be terminated when the moisture content in the air at the outlet of the air conditioning device 20 is 20% or more of that moisture content. By determining the termination of the regeneration mode in this manner, the regeneration mode at the start-up can be efficiently performed and waste of power consumption can be reduced.

Each component of the air conditioning system 100 will be described below in detail.

### (1. Air Conditioning Duct 10)

The air conditioning duct 10 is a flow path that can allow the air from the room interior or the room exterior (the vehicle interior or the vehicle exterior for the vehicle) to flow therethrough. The upstream side of the air conditioning duct 10 is connected to the room interior (vehicle interior) or an outside air introduction port. The air conditioning duct 10 allows the air from the room interior or the room exterior (vehicle interior or vehicle exterior) to flow in, and also allows the air that has passed through the air conditioning device 20 to flow in the room interior (vehicle interior) or flow out to the room exterior (vehicle exterior). Therefore, on a downstream side of the air conditioning device 20, the air conditioning duct 10 preferably branches into the first flow path 10a that allows the air to flow into the room interior (vehicle interior), and the second flow path 10b that allows the air to be discharged to the room exterior (vehicle exterior).

The air conditioning duct 10 may include a valve 50 that can switch the flow of the air between the first flow path 10a and the second flow path 10b. The valve 50 is not particularly limited as long as it is electrically driven and has the function of switching the flow path, and a solenoid valve, an electric valve, and the like can be used. For example, the valve 50 includes an opening/closing door supported by a rotating shaft and an actuator such as a motor that rotates the rotating shaft. The actuator can be configured to be controllable by the control unit 30.

### (2. Air Conditioning Device 20)

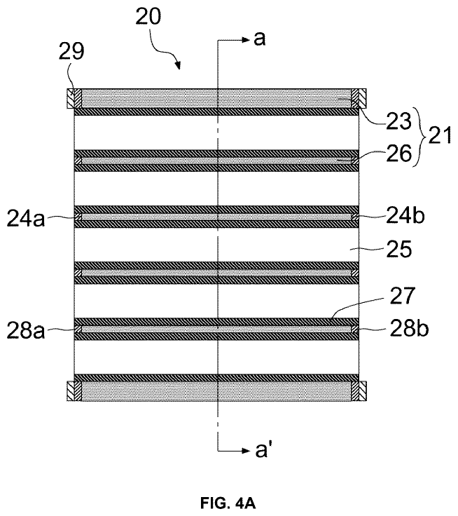

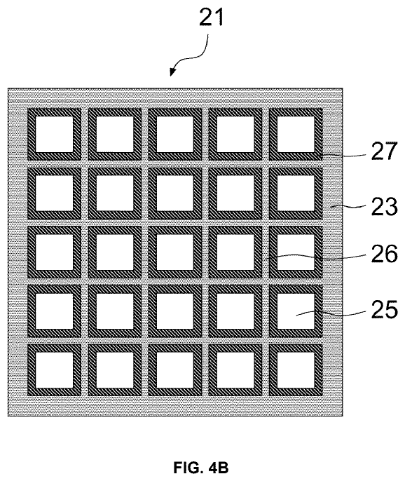

FIG. 4A is a schematic view of a cross section of an air conditioning device used in an air conditioning system according to an embodiment, which is parallel to a flow path direction. FIG. 4B is a schematic cross-sectional view of the air conditioning device in FIG. 4A taken along the line a-a′.

As illustrated in FIGS. 2A and 2B, the air conditioning device 20 includes: a honeycomb structure 21 having an outer peripheral wall 23 and partition walls 26 provided on an inner side of the outer peripheral wall 23, the partition walls 26 defining a plurality of cells 25 each extending from a first end face 24a to a second end face 24b of the honeycomb structure 21 to form a flow path for air; an adsorbing layer 27 containing an adsorbent, the adsorbing layer 27 being provided on a surface of each of the partition walls 26; and a pair of electrodes 28a, 28b provided on the first end face 24a and the second end face 24b of the honeycomb structure 21. Also, the humidity control device 20 may further include terminals 29 connected to the pair of electrodes 28a, 28b.

### (2-1. Honeycomb Structure 21)

The shape of the honeycomb structure 21 is not particularly limited. For example, an outer shape of a cross section of the honeycomb structure 21 orthogonal to the flow path direction (extending direction of the cells 25) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 24a and second end face 24b) have the same shape as the cross section. Also, when the cross section and the end faces are polygonal, the corners may be chamfered.

The shape of each cell 25 is not particularly limited, but it may be polygonal such as quadrangular, pentagonal, hexagonal, heptagonal, and octagonal, circular, or oval in the cross section of the honeycomb structure 21 orthogonal to the flow path direction. These shapes may be alone or in combination of two or more. Moreover, among these shapes, the quadrangle or the hexagon is preferable. By providing the cells 25 having such a shape, it is possible to reduce the pressure loss when the air flows.

The honeycomb structure 21 may be a honeycomb joined body that includes a plurality of honeycomb segments and joining layers that join outer peripheral side surfaces of the plurality of honeycomb segments together. The use of the honeycomb joined body can increase the total cross-sectional area of the cells 25, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 23 and the partition walls 26. In addition to the role of joining the honeycomb segments to each other, the joining material can also be used as an outer peripheral coating material after joining the honeycomb segments.

From the viewpoints of ensuring the strength of the honeycomb structure 21, reducing pressure loss when air passes through the cells 25, ensuring the amount of functional material supported, and ensuring the contact area with the air flowing inside the cells 25, it is desirable to suitably combine a thickness of the partition wall 26, a cell density, and a cell pitch (or an opening ratio of the cells 25).

As used herein, the cell density refers a value obtained by dividing a number of cells by an area of one end face (first end face 24a or second end face 24b) of the honeycomb structure 21 (the total area of the partition walls 26 and the cells 25 excluding the outer peripheral wall 23).

As used herein, the cell pitch refers to a value obtained by the following calculation. First, the area of one end face (first end face 24a or second end face 24b) of the honeycomb structure 21 (the total area of the partition walls 26 and the cells 25 excluding the outer peripheral wall 23) is divided by the number of the cells to calculate an area per a cell. A square root of the area per a cell is then calculated, and this is determined to be the cell pitch.

As used herein, the opening ratio of the cells 25 refers a value obtained by dividing the total area of the cells 25 defined by the partition walls 26 by the area of one end face (first end face 24a or second end face 24b) (the total area of the partition walls 26 and the cells 25 excluding the outer peripheral wall 23) in the cross section orthogonal to the flow path direction of the honeycomb structure 21. It should be noted that when calculating the opening ratio of the cells 25, the pair of electrodes 28a, 28b, and the adsorbing layer 27 are not taken into account.

In an embodiment that is advantageous from the viewpoint of supporting a sufficient amount of functional material, the thickness of the partition walls 26 is 0.300 mm or less, the cell density is 100 cells/cm² or less, and the cell pitch is 1.0 mm or more. In a preferred embodiment, the thickness of the partition walls 26 is 0.200 mm or less, the cell density is 70 cells/cm² or less, and the cell pitch is 1.2 mm or more. In a more preferred embodiment, the thickness of the partition walls 26 is 0.130 mm or less, the cell density is 65 cells/cm² or less, and the cell pitch is 1.3 mm or more.

From the viewpoints of ensuring the strength of the honeycomb structure 21 and maintaining lower electrical resistance, the lower limit of the thickness of the partition wall 26 is preferably 0.010 mm or more, more preferably 0.020 mm or more, and even more preferably 0.030 mm or more.

From the viewpoints of ensuring the strength of the honeycomb structure 21, maintaining lower electrical resistance, and increasing a surface area to facilitate reaction, adsorption, and separation, the lower limit of the cell density is 30 cells/cm² or more, preferably 35 cells/cm² or more, and even more preferably 40 cells/cm² or more.

From the viewpoints of ensuring the strength of the honeycomb structure 21, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 26 is 0.08 to 0.36 mm, the cell density is 2.54 to 140 cells/cm², and the opening ratio of the cells 25 is 0.70 or more. In a preferred embodiment, the thickness of the partition walls 26 is 0.09 to 0.35 mm, the cell density is 15 to 100 cells/cm², and the opening ratio of the cells 25 is 0.80 or more. In a more preferred embodiment, the thickness of the partition walls 26 is 0.14 to 0.30 mm, the cell density is 20 to 90 cells/cm², and the opening ratio of the cells 25 is 0.85 or more.

From the viewpoint of ensuring the strength of the honeycomb structure 21, the upper limit of the opening ratio of the cells 25 is preferably 0.94 or less, more preferably 0.92 or less, and even more preferably 0.90 or less.

Although the thickness of the outer peripheral wall 23 is not particularly limited, it is preferably determined based on the following considerations. First, from the viewpoint of reinforcing the honeycomb structure 21, the thickness of the outer peripheral wall 23 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 23 is preferably 1.0 mm or less, more preferably 0.5 mm, even more preferably 0.4 mm or less, and still more preferably 0.3 mm or less.

As used herein, the thickness of the outer peripheral wall 23 refers to a length, in a normal line direction of a side surface of the honeycomb structure 21, from a boundary between the outer peripheral wall 23 and the outermost cell 25 or partition wall 26 to the side surface of the honeycomb structure 21 in the cross section orthogonal to the flow path direction of the honeycomb structure 21.

The length of the honeycomb structure 21 in the flow path direction and the cross-sectional area of the honeycomb structure 11 orthogonal to the flow path direction may be adjusted according to the required size of the air conditioning device 20, and are not particularly limited. For example, when used in a compact air conditioning device 20 while ensuring a predetermined function, the honeycomb structure 21 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 26 forming the honeycomb structure 21 are preferably made of a material that can be heated by electric conduction, specifically made of a material having a PTC property. Further, the outer peripheral wall 23 may also be made of a material having a PTC property, as with the partition walls 26, as needed. By such a configuration, the adsorbing layer 27 can be directly heated by heat transfer from the heat-generating partition walls 26 (and optionally the outer peripheral wall 23). Further, the material having the PTC property has characteristics such that when the temperature increases to exceed the Curie point, the resistance value is sharply increased, making it difficult for electricity to flow. Therefore, when the temperature of the partition walls 26 (and the outer peripheral wall 23 if necessary) becomes high, the current flowing through them is limited, thereby suppressing excessive heat generation of the honeycomb structure 21. Therefore, it is possible to suppress thermal deterioration of the adsorbing layer 27 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints that can be heated by electric conduction and has the PTC property, the outer peripheral wall 23 and the partition walls 26 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 23 and the partition walls 26 are substantially free of lead (Pb). Specifically, the outer peripheral wall 23 and the partition walls 26 preferably have a Pb content of 0.01% by mass or less, and more preferably 0.001% by mass or less, and still more preferably 0% by mass. The lower Pb content can allow the air heated by contact with the heat-generating partition walls 26 to be safely applied to organisms such as humans, for example. In the outer peripheral wall 23 and the partition walls 26, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 23 and the partition walls 26 is preferably in a temperature range where the resistance value is twice or more the resistance at room temperature (25° C.). If the Curie point is in such a temperature range, the current flowing through the air conditioning device 20 will be limited when the temperature of the air conditioning device 20 becomes high, so that any excessive heat generation of the air conditioning device 20 will be efficiently suppressed. Therefore, thermal deterioration of the adsorbing layer 27 caused by excessive heat generation can be suppressed.

In terms of efficiently heating the adsorbing layer 27, the material making up the outer peripheral wall 23 and the partition walls 26 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 23 and the partition walls 26 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### (2-2. Pair of Electrodes 28a, 28b)

A pair of electrodes 28a, 28b may be provided on the first end face 24a and the second end face 24b as shown in FIG. 4A, although the positions of the electrodes 28a, 28b are not limited thereto. Also, the pair of electrodes 28a, 28 b may be provided on the outer peripheral wall 23 parallel to the extending direction of the cells 25 of the honeycomb structure 21.

Applying of a voltage between the pair of electrodes 28a, 28 b allows the honeycomb structure 21 to generate heat by Joule heat.

The pair of electrodes 28a, 28 b may employ, for example, a metal or alloy containing at least one selected from Cu, Ag, Al, Ni and Si, although not particularly limited thereto. It is also possible to use an ohmic electrode capable of ohmic contact with the outer peripheral wall 23 and/or the partition walls 26 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 28a, 28b may have a single-layer structure, or may have a laminated structure of two or more layers. When the pair of electrodes 28a, 28 b have the laminated structure of two or more layers, the materials of the respective layers may be of the same type or of different types.

The thickness of the pair of electrodes 28a, 28b may be appropriately set according to the method for forming the pair of electrodes 28a, 28b. The method for forming the pair of electrodes 28a, 28b includes metal deposition methods such as sputtering, vapor deposition, electrolytic deposition, and chemical deposition. Alternatively, the pair of electrodes 28a, 28b can be formed by applying an electrode paste and then baking it, or by thermal spraying. Furthermore, the pair of electrodes 28a, 28b may be formed by joining metal sheets or alloy sheets.

Each of the thicknesses of the pair of electrodes 28a, 28 b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (3-3. Terminal 29)

The terminals 29 are connected to the pair of electrodes 28a, 28b, and provided on at least part of the pair of electrodes 28a, 28b. The provision of the terminals 29 facilitates connection to an external power supply. The terminals 29 are connected to a conductor connected to the external power supply.

The terminals 29 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 29 are not particularly limited. For example, as shown in FIG. 4A, the terminals 29 can be provided on the whole of the pair of electrodes 28a, 28b on the outer peripheral wall 23. Further, the terminals 29 may be provided on a part of the pair of electrodes 28a, 28b on the outer peripheral wall 23, or may be provided so as to extend toward an outer side than the outer edge of each of the pair of electrodes 28a, 28b on the outer peripheral wall 23. Further, the terminals 29 may be provided on a part of the pair of electrodes 28a, 28b on the partition walls 26, or may be provided so as to block a part of the cells 25.

Furthermore, the thickness of the terminal 29 is not particularly limited, but it is, for example, 0.01 to 10 mm, typically 0.05 to 5 mm.

The method of connecting the terminals 29 to the pair of electrodes 28a, 28b is not particularly limited as long as they are electrically connected. For example, they can be connected by diffusion bonding, a mechanical pressing mechanism, welding, or the like.

### (2-4. Adsorbing Layer 27)

The adsorbing layer 27 contains an adsorbent.

The adsorbing layer 27 can be provided on the surfaces of the partition walls 26 (in the case of the outermost cells 25, the partition walls 26 that define the outermost cells 25 and the outer peripheral wall 23). By thus providing the adsorbing layer 27, the adsorption target substance is easily adsorbed during the adsorption process, and the adsorbing layer 27 can be easily heated during the regeneration mode, so that the desirable function by the adsorbing layer 27 can be regenerated.

The adsorbing layer 27 is capable of adsorbing and separating the adsorption target substance. Specifically, the adsorbing layer 27 is preferably capable of adsorbing and separating one or more selected from moisture, carbon dioxide and volatile components. For example, the adsorbing layer 27 can contain at least one adsorbent that can adsorb these components. If one adsorbent can adsorb all the moisture, carbon dioxide and volatile components, the moisture, the carbon dioxide and the volatile components can be adsorbed by including only that adsorbent. By containing such an adsorbent, it is possible to obtain an effect of purifying the air.

The adsorbent contained in the adsorbing layer 27 preferably has a function that can adsorb the adsorption target substance at −20 to 40° C. and separate it at an elevated temperature of 60° C. or more.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the room interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 27 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 27 may be determined according to the size of the cells 25, and is not particularly limited. For example, from the viewpoint of ensuring sufficient contact with air, the thickness of the adsorbing layer 27 is preferably 20 μm or more, more preferably 25 μm or more, and even more preferably 30 μm or more. On the other hand, from the viewpoint of suppressing separation of the adsorbing layer 27 from the partition walls 26 and the outer peripheral wall 23, the thickness of the adsorbing layer 27 is preferably 400 μm or less, more preferably 380 μm or less, and even more preferably 350 μm or less.

The thickness of the adsorbing layer 27 is measured using the following procedure. Any cross section of the honeycomb structure 21 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 21. The thickness of each adsorbing layer 27 visually recognized from the cross-sectional image is calculated by dividing the cross-sectional area by the length of the cells 25 in the flow path direction. This calculation is performed for all the adsorbing layers 27 visually recognized from the cross-sectional image, and an average value thereof is determined to be the thickness of the adsorbing layer 27.

From the viewpoint of exerting a desired function in the air conditioning device 20, an amount of the adsorbing layer 27 is preferably 50 to 500 g/L, more preferably 100 to 400 g/L, and even more preferably 150 to 350 g/L, based on the volume of the honeycomb structure 21. It should be noted that the volume of the honeycomb structure 21 is a value determined by the external dimensions of the honeycomb structure 21.

### (2-5. Method for Producing Air Conditioning Device 20)

The method for producing the air conditioning device 20 according to the embodiment of the disclosure is not particularly limited, and it can be performed according to a known method. Hereinafter, the method for producing the air conditioning device 20 according to an embodiment of the disclosure will be illustratively described.

A method for producing the honeycomb structure 21 forming the air conditioning device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 21 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 21 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 21.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. The maintaining at 900 to 950° C. for 0.5 to 5 hours can lead to sufficient decomposition of BaCO₃, so that the honeycomb structure 21 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 28a, 28b is formed on the honeycomb structure 21 thus obtained. The pair of electrodes 28a, 28b can be formed by metal deposition methods such as sputtering, vapor deposition, electrolytic deposition, and chemical deposition. Further, the pair of electrodes 28a, 28b can also be formed by applying an electrode paste and then baking it. Furthermore, the pair of electrodes 28a, 28b can also be formed by thermal spraying. The pair of electrodes 28a, 28b may be composed of a single layer, but may also be composed of a plurality of electrode layers having different compositions. A typical method for forming the pair of electrodes 28a, 28b will be described below.

First, an electrode slurry containing an electrode material, an organic binder, and a dispersion medium is prepared, and the first end face 24a or the second end face 24 b of the honeycomb structure 21 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 21 is removed by blowing and wiping. The slurry can be then dried to form the pair of electrodes 28a, 28 b on the first end face 24a or the second end face 24 b of the honeycomb structure 21. The drying can be performed while heating the honeycomb structure 21 to a temperature of about 120 to 600° C., for example. Although a series of steps of coating, slurry removal, and drying may be performed only once, the steps can be repeated multiple times to provide the pair of electrodes 28a, 28 b having desired thicknesses.

The terminals 29 are then disposed at predetermined positions of the pair of electrodes 28a, 28b, and the pair of electrodes 28a, 28b and the terminals 29 are connected to each other. As a method of connecting the pair of electrodes 28a, 28b to the terminals 29, the method described above can be used.

It should be noted that the terminals 29 may be placed after forming the adsorbing layer 27 described below.

The adsorbing layer 27 is then formed on the surfaces of the partition walls 26 and the like of the honeycomb structure 21.

Although the method for forming the adsorbing layer 27 is not particularly limited, it can be formed, for example, by the following steps. The honeycomb structure 21 is immersed in a slurry containing an adsorbent, an organic binder, and a dispersion medium for a predetermined period of time, and an excess slurry on the end faces and the outer periphery of the honeycomb structure 21 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 27 on the surfaces of the partition walls 26. The drying can be performed while heating the honeycomb structure 21 to a temperature of about 120 to 600° C., for example. Although a series of steps of immersion, slurry removal, and drying may be performed only once, the steps can be repeated multiple times to provide the adsorbing layer 27 having the desired thickness on the surfaces of the partition walls 26 and the like.

### (3. Power Source 40)

The power source 40 is for applying a voltage to the air conditioning device 20 (in particular, the pair of electrodes 28a, 28b). The power source 40 is electrically connected to the control unit 30, and adjusts the state of the voltage applied to the pair of electrodes 28a, 28b according to instructions from the control unit 30.

The power source 40 is not particularly limited, and a battery or the like can be used.

### (4. Ventilation Fan 60)

The ventilation fan 60 is a device for allowing the air from the room interior or the room exterior (vehicle interior or vehicle exterior) to flow into the air conditioning device 20, and is provided in the air conditioning duct 10. The position of the ventilation fan 60 is not limited, but it may be on the upstream side of the air conditioning device 20, for example, as shown in FIG. 1, or on the downstream side of the air conditioning device 20.

The ventilation fan 60 is electrically connected to the control unit 30 and can control the flow velocity of the air by adjusting the rotation speed according to instructions from the control unit 30.

### (5. Control Unit 30)

Also, the control unit 30 is electrically connected to the power source 40, the valve 50, the ventilation fan 60, and the like, and it can control these members. The control unit 30 can control the power source 40, thereby adjusting the heating state of the honeycomb structure 21 by controlling a voltage applying state to the pair of electrodes 28a, 28b of the air conditioning device 20. Further, the control unit 30 can also control the valve 50 so that the air flows through the first flow path 10a or the second flow path 10b. Furthermore, the control unit 30 can adjust the rotation speed of the ventilation fan 60, thereby controlling the flow velocity of the air flowing through the air conditioning duct 10.

The control unit 30 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 30 can execute an adsorption mode configured to switch the valve 50 so that the air flows into the first flow path 10a, and a regeneration mode configured to heat the adsorption portion (adsorbing layer 27) and switch the valve 50 so that the air flows into the second flow path 10b. That is, the control unit 30 is configured to execute an adsorption mode for turning off the applied voltage from the power source 40 and switching the valve 50 so that the air flows through the first flow path 10a, and a regeneration mode for turning on the applied voltage from the power source 40 and switching the valve 50 so that the air flows through the second flow path 10b. By executing the adsorption mode and the regeneration mode in such a manner, the adsorption process and the regeneration process can be efficiently carried out.

In the case of the adsorption mode, the adsorption target substance in the air flowing from the room interior or the room exterior (vehicle interior or vehicle exterior) are captured (adsorbed) by the above control with the control unit 30. At this time, the honeycomb structure 21 of the air conditioning device 20 is not heated. Specifically, the air from the room interior or the room exterior (vehicle interior or vehicle exterior) flows in the air conditioning device 20 through the air conditioning duct 10, and the adsorption target substance contained in the air are captured (adsorbed). The air that has captured the adsorption target substance is returned to the room interior (vehicle interior) through the first flow path 10a.

In the case of the regeneration mode, the adsorbing layer 27 of the air conditioning device 20 is regenerated by the above control with the control unit 30. At this time, the honeycomb structure 21 of the air conditioning device 20 is heated. Specifically, the air from the room interior or the room exterior (vehicle interior or vehicle exterior) flows in the air conditioning device 20 through the air conditioning duct 10, and separates the adsorption target substance captured in the adsorbing layer 27 while passes through the air conditioning device 20. Then, the air containing the moisture is discharged to the room exterior (vehicle exterior) through the second flow path 10b.

When the air conditioning system 100 is for vehicles, from the viewpoint of stably performing the above control, it is desirable that the air conditioning device 20 be placed at a position close to the vehicle interior. Therefore, from the viewpoint of preventing electric shock and the like, it is preferable that the driving voltage of the air conditioning device 20 is 60V or less. Since the honeycomb structure 21 used in the air conditioning device 20 has a low electrical resistance at room temperature, the honeycomb structure 21 can be heated at the low driving voltage. It should be noted that the lower limit of the driving voltage is not particularly limited, but it may preferably be 10 V or more. If the driving voltage is less than 10V, the current during heating the honeycomb structure 21 becomes large, so that the conductor wire should be thick.

### DESCRIPTION OF REFERENCE NUMERALS

10 air conditioning duct
10a first flow path
10b second flow path
20 air conditioning device
21 honeycomb structure
23 outer peripheral wall
24a first end face
24b second end face
25 cell
26 partition wall
27 adsorbing layer
28a, 28b pair of electrodes
29 terminal
30 control unit
40 power source
50 valve
60 ventilation fan
100 air conditioning system

1. An air conditioning system, comprising:
an air conditioning duct through which air can flow;
at least one air conditioning device provided in the air conditioning duct, the at least one air conditioning device comprising an adsorption portion having at least one adsorbent configured to adsorb and separate an adsorption target substance, and a heating means configured to heat the adsorption portion; and
a control unit configured to control a flow velocity of air flowing through the air conditioning duct and heating of the adsorption portion,
wherein the control unit repeatedly executes an adsorption mode in which the heating means of the air conditioning device is not activated, and a regeneration mode in which the heating means of the air conditioning device is activated, and executes the regeneration mode at start-up.

2. The air conditioning system according to claim 1, wherein a time during the regeneration mode at the start-up is longer than a time during the regeneration mode other than the start-up.

3. The air conditioning system according to claim 1, wherein the control unit executes the regeneration mode at the start-up until an adsorbed amount of the adsorption portion is 20% or less of the maximum adsorbed amount.

4. The air conditioning system according to claim 3, wherein the control unit previously determines a relationship between a time during the regeneration mode and an adsorbed amount of the adsorption portion, measures the adsorbed amount of the adsorption portion at the start-up, and calculates a time during the regeneration mode at the start-up based on the relationship and execute the regeneration mode.

5. The air conditioning system as according to claim 1, wherein the control unit measures amounts of components contained in the air that passed through the air conditioning device during the regeneration mode at the start-up, and determines the end of the regeneration mode at the start-up based on results of the measurement.

6. The air conditioning system according to claim 1, wherein the air conditioning device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer comprising the adsorbent, the adsorbing layer being provided on a surface of each of the partition walls; and
a pair of electrodes provided on the first end face and the second end face of the honeycomb structure, or on the outer peripheral wall parallel to the extending direction of the cells of the honeycomb structure.

7. The air conditioning system according to claim 6, wherein at least the partition walls of the honeycomb structure are made of a material having a positive temperature coefficient (PTC) property.

8. The air conditioning system according to claim 1, wherein the adsorbent is configured to adsorb and separate at least one selected from moisture, carbon dioxide and volatile components.

9. The air conditioning system according to claim 1, wherein the air conditioning system is for vehicles.

10. The air conditioning system according to claim 9, wherein the air conditioning duct branches into a first flow path for allowing the air to flow into the vehicle interior and a second flow path for discharging the air to a vehicle exterior on a downstream side, and wherein the air conditioning duct further comprises a valve configured to switch the flow of the air between the first flow path and the second flow path.

11. The air conditioning system according to claim 10,
wherein the control unit is configured to control the valve, and
wherein the control unit is configured to perform an adsorption mode configured to switch the valve so that the air flows into the first flow path, and a regeneration mode configured to heat the adsorption mode and switch the valve so that the air flows into the second flow path.
